(19) United States
(12) Patent Application Publication
(10) Pub. No.: US 2008/0232084 A1
(43) Pub. Date: Sep. 25, 2008

(54) WHITE LIGHT SOURCE DEVICE

(75) Inventor: Shusaku Kon, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC LIGHTING, LTD, Tokyo (JP)

(21) Appl. No.: 12/040,257

(22) Filed: Feb. 29, 2008

(30) Foreign Application Priority Data
Mar. 19, 2007 (JP) 2007-070546

(51) Int. Cl. F21V 9/16

(52) U.S. Cl. 362/84

(57) ABSTRACT

Light beams emitted from a blue LED light source of a light source unit are condensed by a condenser lens to enter an entrance end face of a rod lens, and the light beams progress through while being repeatedly reflected several times inside the rod lens. Accordingly, the unevenness of brightness is reduced, and the light enters an fluorescent material sheet bonded to an exit end of the rod lens from the exit end as blue light which is uniformed in illuminance, and white light whose color is seen as the same color viewed in any direction of the fluorescent material sheet is emitted from the fluorescent material sheet.

This application is based upon and claims the benefit of priority from Japanese patent application No. 2007-070546, filed on Mar. 19, 2007, the disclosure of which is incorporated herein in its entirety by reference.

### BACKGROUND OF THE INVENTION

1. Field of the Invention

The present invention relates to a white light source device, and particularly to a white light source device including a rod lens.

2. Description of the Related Art

Conventionally, there has been a white light source that emits white light by mixing blue light emitted from a blue light emitting element, which is sealed with a transparent binder containing fluorescent material, with excited light emitted from the fluorescent material on which the blue light fell. In the white light source having such a structure, the output efficiency of the white light was low, because of large absorption of light in the blue light emitting element and the fluorescent material. A considerable part of the light emitted from the blue light emitting element, was reflected by the fluorescent material and returned to the blue light emitting element. In the blue light emitting element, the light cannot be easily exited outside again because of the high refractive index, resulting in high rate of absorption of the light. Further, a considerable part of the light entering a fluorescent material layer is absorbed in the fluorescent material layer, resulting in low light output efficiency for the white light emitted from the fluorescent material layer.

As one alternative means for combining a light emitting element and fluorescent material, there is a method by which the light emitting element is allocated away from a sheet in which the fluorescent material is dispersed. For example, Japanese Patent Laid-Open No. 2006-49814 discloses a light emitting apparatus in which two-tiered reflecting members, which surround a light emitting element on a substrate and which have a circular reflecting surface therein, are provided, and in which a wavelength conversion layer for converting an optical wavelength, which contains fluorescent material is provided in the upper portion of the light emitting element.

Japanese Patent Laid-Open No. 2004-212469 discloses a lighting device in which exiting light from a plurality of LEDs (light-emitting diodes) enters a rod integrator to emit a uniform exiting light having high light intensity. Further, Japanese Patent Laid-Open No. 2005-99328 discloses a lighting device in which an LED chip is provided in a concave portion on the entrance end side of a rod lens, which provides for uniform illuminance distribution, and reduced size, weight, and cost. However, the configuration disclosed in Japanese Patent Laid-Open No. 2005-99328 does not have a fluorescent material sheet provided therein.

Japanese Patent Laid-Open No. 2005-339853 discloses a light source device in which white light emitted from a fluorescent substance surrounding a blue LED enters a rod lens to suppress unevenness of color in an illumination surface. However, Japanese Patent Laid-Open No. 2005-339853 does not describe a configuration in which exiting light from the blue LED enters the fluorescent substance through the rod lens.

Light from an LED has a characteristic that light intensity changes depending on the light exit angle. Accordingly, in the case of an LED, it is difficult to control light distribution by using a reflector, compared to the case of an electric bulb. According to the method by which the sheet in which fluorescent material is dispersed is placed away from the light emitting element to provide a white light source, light from an LED is not uniformly illuminated on a surface of the sheet, and considerable unevenness of color is generated between the central portion and the end portion. Unevenness of color is a serious problem especially when the white light is used for general illumination, so that the unevenness of color has to be reduced as much as possible.

### SUMMARY OF THE INVENTION

An object of the present invention is to provide a white light source device capable of reducing unevenness of color by combining a light emitting element and a sheet in which fluorescent material is dispersed.

To achieve the object described above, a white light source device of the present invention includes: an LED light source; a rod lens for emitting a uniform light beam from an exit end face after making an incoming light beam, that entered an entrance end face from the LED light source, uniform; and a fluorescent material sheet provided close to the exit end face of the rod lens.

A condenser lens may be provided that condenses beams of that exit light from the LED light source on the entrance end face of the rod lens. Further, a reflector may be provided that condenses beams of light that exit from the LED light source on the entrance end face of the rod lens. Also, the LED light source may be provided directly close to the entrance end face of the rod lens.

The LED light source may be a blue LED light source. Then, the fluorescent material sheet may be a translucent sheet on which yellow fluorescent material is arranged, with light emitted from the fluorescent material excited by blue light incoming from the LED light source is mixed with the blue light incoming from the LED light source to emit white light.

Also, the LED light source may be a blue LED light source. Then, the fluorescent material sheet may be a translucent sheet on which red fluorescent material and green fluorescent material are arranged, with light emitted from the fluorescent materials excited by blue light incoming from the LED light source is mixed with the blue light incoming from the LED light source to emit white light.

The LED light source may be a near-ultraviolet emitting LED light source. Then, the fluorescent material sheet may be a translucent sheet on which red fluorescent material, green fluorescent material, and blue fluorescent material are arranged, with white light is emitted from the fluorescent materials excited by a near-ultraviolet ray incoming from the LED light source.

A rod lens, which intervenes in the path of highly directive light from an LED, enhances light uniformity at an exit face of the rod lens, and this light that was uniformized, is illuminated directly on the fluorescent material sheet, which can provide white light which is evenly colored.

According to the present invention, because the rod lens is placed between the LED light source and the sheet in which fluorescent material is dispersed, highly uniform light can be illuminated on the fluorescent material sheet to suppress color separation in the fluorescent material sheet, which can provide white light without unevenness of color.

### BRIEF DESCRIPTION OF THE DRAWINGS

FIG. 1 is a side view schematically illustrating a white light source device of a first exemplary embodiment;

FIG. 2 is a side view schematically illustrating a white light source device of a second exemplary embodiment; and

FIG. 3 is a side view schematically illustrating a white light source device of a third exemplary embodiment.

### DETAILED DESCRIPTION OF THE PREFERRED EMBODIMENTS

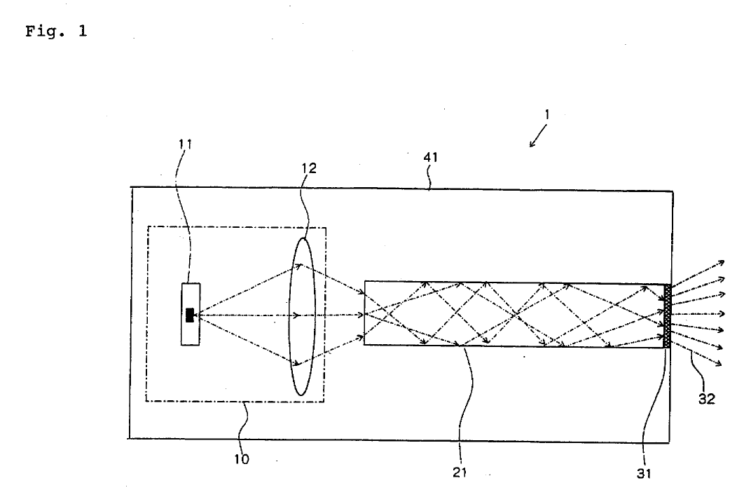

Now, exemplary embodiments of the present invention will be hereinafter described with reference to the accompanying drawings. FIG. 1 is a side view schematically illustrating a white light source device of a first exemplary embodiment.

White light source device 1 of the first exemplary embodiment includes: light source unit 10 including blue LED light source 11 composed of a blue LED and condenser lens 12 for condensing blue light beams emitted from blue LED light source 11 on an entrance face of rod lens 21; rod lens 21; fluorescent material sheet 31 bonded to an exit face of rod lens 21; and casing 41 for forming a chassis.

Electric current is supplied by a power supply not shown in the figure through a switch to blue LED light source 11. Rod lens 21 is a transparent body having a quadratic prism shape, and an inner face of an outer circumferential wall thereof is configured to be a reflecting face. A light beam that entered rod lens 21 progresses while occasionally being repeatedly reflected inside rod lens 21, thereby unevenness of brightness is reduced in an exit end of rod lens 21. In addition, here, the description will be provided in the case of a rod lens, but in the case where a light tunnel having a hollow and a quadratic prism shape is used, a similar effect may be also provided. Further, a transparent, optical element having a cylinder column shape may be used for the light tunnel.

Fluorescent material sheet 31 is a translucent sheet on which yellow fluorescent material is arranged, with light emitted from the fluorescent material excited by blue light incoming from blue LED light source 11 is mixed with the blue light incoming from blue LED light source 11 to emit white light.

As described above, light from an LED has a characteristic in which the light intensity changes depending on the light exit angle. Therefore, there is a problem in which unevenness of color is generated in the white light emitted from fluorescent material sheet 31 when the LED light is illuminated on fluorescent material sheet 31.

The blue light beams emitted from blue LED light source 11 of light source unit 10 are condensed by condenser lens 12 to enter an entrance end face of rod lens 21, and the blue light beams progress through while being repeatedly reflected several times inside rod lens 21. Accordingly, the unevenness of brightness is reduced, and the light enters fluorescent material sheet 31 bonded to an exit end of rod lens 21 from the exit end as blue light having uniform illuminance. Therefore, white light 32 whose color is seen as the same color viewed in any direction of fluorescent material sheet 31 is emitted from fluorescent material sheet 31.

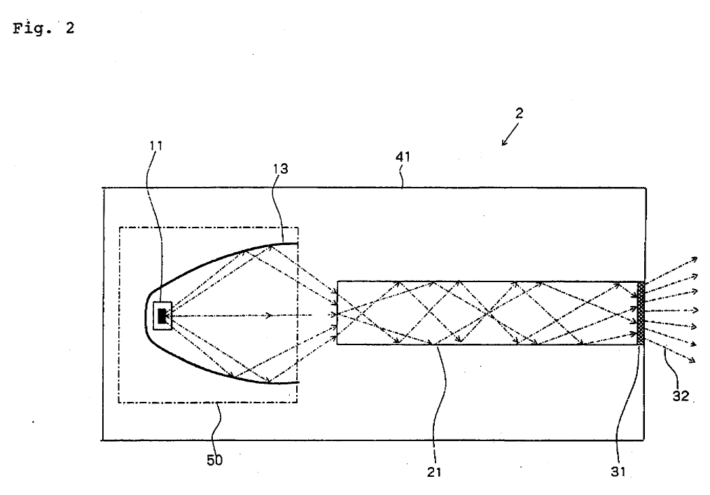

Next, a second exemplary embodiment will be described with reference to the accompanying drawings. FIG. 2 is a side view schematically illustrating a white light source device of the second exemplary embodiment.

White light source device 2 of the second exemplary embodiment has the same configuration and function as the first exemplary embodiment, except that a light condensing means for condensing beams of exiting light from blue LED light source 11 on rod lens 21 is changed from condenser lens 12 to reflector 13. Accordingly, a like component as that of the first exemplary embodiment is indicated by a like symbol and the description is omitted.

Light source unit 50 included in white light source device 2 of the second exemplary embodiment is configured to include blue LED light source 11 and reflector 13. In white light source device 2, beams of exiting light from blue LED light source 11 are condensed by reflector 13 to enter the entrance end face of rod lens 21.

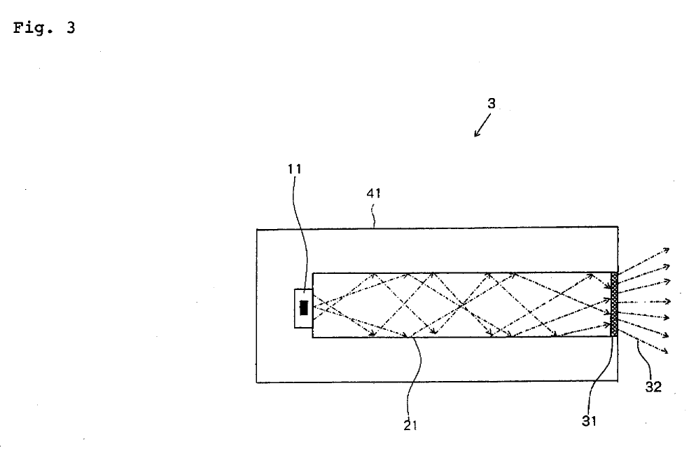

Next, a third exemplary embodiment will be described with reference to the accompanying drawings. FIG. 3 is a side view schematically illustrating a white light source device of the third exemplary embodiment.

In white light source device 3 of the third exemplary embodiment, an exit face of blue LED light source 11 is in direct contact with the entrance end face of rod lens 21. The present exemplary embodiment has the same configuration and function as the first exemplary embodiment, except that the light exiting from blue LED light source 11 directly enters rod lens 21. Accordingly, a like component as that of the first exemplary embodiment is indicated by a like symbol and the description is omitted.

A blue light directly entering rod lens 21 from blue LED light source 11 diffuses in the proximity of the entrance of rod lens 21 and the blue light progresses through while being repeatedly reflected several times inside rod lens 21. Although it is necessary to extend rod lens 21 by a diffusion distance, but condenser lens 12 and reflector 13 become unnecessary, thereby enabling a compact configuration.

Fluorescent material sheet 31 has been most widely used. Fluorescent material sheet 31 has been described as the translucent sheet on which the fluorescent material is arranged, with the light emitted from the yellow fluorescent material excited by the blue light incoming from blue LED light source 11 is mixed with the blue light incoming from blue LED light source 11 to emit white light. However, the present invention may be also similarly applied to a configuration, formed by combining a light emitting body and fluorescent, coloring material, and which is capable of providing white light, as the fluorescent material sheet.

As for the combination of the light emitting body and the fluorescent, coloring material that is capable of providing white light, a configuration formed of, for example, a combination of “a blue light-emitting diode” and “fluorescent, green coloring material”+“fluorescent, brown coloring material”, or a combination of “a near-ultraviolet light-emitting diode” and “fluorescent, blue coloring material”+“fluorescent, green coloring material”+“fluorescent, red coloring material” may be used. In such configurations, by placing rod lens 21 between the light-emitting diode and the fluorescent material sheet having the fluorescent material arranged thereon, white light 32 whose color is seen as the same color viewed in any direction of fluorescent material sheet 31 is emitted from fluorescent material sheet 31.

Besides these configurations, a configuration such as a combination of “a blue light-emitting diode” and “fluorescent, yellow coloring material”+“fluorescent, red coloring material”, or a combination of “a near-ultraviolet light-emitting diode” and “fluorescent, blue coloring material”+“fluorescent, green coloring material”+“fluorescent, brown coloring material” may be used. Also in such configurations, the rod lens may be similarly used.

While the invention has been shown and described with particular reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A white light source device, comprising:
an LED light source,
a rod lens for emitting a uniform light beam from an exit end face after making an incoming light beam that entered an entrance end face from the LED light source uniform, and
a fluorescent material sheet provided close to the exit end face of the rod lens.

2. The white light source device according to claim 1, further comprising:
a condenser lens for condensing beams of light exiting from the LED light source on the entrance end face of the rod lens.

3. The white light source device according to claim 1, further comprising:
a reflector for condensing beams of light exiting from the LED light source on the entrance end face of the rod lens.

4. The white light source device according to claim 1, wherein
the LED light source is provided directly close to the entrance end face of the rod lens.

5. The white light source device according to claim 1, wherein
the LED light source is a blue LED light source, and
the fluorescent material sheet is a translucent sheet on which yellow fluorescent material is arranged, with light emitted from the fluorescent material excited by blue light incoming from the LED light source is mixed with the blue light incoming from the LED light source to emit white light.

6. The white light source device according to claim 1, wherein
the LED light source is a blue LED light source, and
the fluorescent material sheet is a translucent sheet on which red fluorescent material and green fluorescent material are arranged, with light emitted from the fluorescent materials excited by blue light incoming from the LED light source is mixed with the blue light incoming from the LED light source to emit white light.

7. The white light source device according to claim 1, wherein
the LED light source is a near-ultraviolet emitting LED light source, and
the fluorescent material sheet is a translucent sheet on which red fluorescent material, green fluorescent material, and blue fluorescent material are arranged, with white light is emitted from the fluorescent materials excited by a near-ultraviolet ray incoming from the LED light source.
